(19) United States
(12) Patent Application Publication
(10) Pub. No.: US 2024/0242170 A1
(43) Pub. Date: Jul. 18, 2024

(54) METHOD AND SYSTEM FOR MANAGING UNDELIVERABLE PACKAGES

(71) Applicant: Target Brands, Inc., Minneapolis, MN (US)

(72) Inventors: BILL BERGMANN, Minneapolis, MN (US); MRUDANG DESAI, Minneapolis, MN (US); JAMES PATRICK PERRONE, Minneapolis, MN (US)

(73) Assignee: Target Brands, Inc., Minneapolis, MN (US)

(21) Appl. No.: 18/096,248

(22) Filed: Jan. 12, 2023

(51) Int. Cl. G06Q 10/0837; G06Q 10/0833; G06Q 10/0836; G06Q 50/30

(52) U.S. Cl. CPC G06Q 10/0837; G06Q 10/0833; G06Q 10/0836; G06Q 50/30

(57) ABSTRACT

Methods and systems for managing undeliverable packages within a retail supply chain are disclosed. One method includes receiving a notification from a delivery driver that a package is undeliverable. A plurality of retail stores participating in a return to store program and within a predetermined geographic proximity of the delivery driver may be identified. Based on the delivery driver's location, whether retail stores have space to receive an undeliverable package, and line haul schedule information, a prioritized list of retail store locations to which the undeliverable item may be returned may be generated. Retail stores with same day line haul pickup available may be prioritized. The prioritized list of retail store may be presented to the delivery driver on a user interface. The delivery driver may select a store and the user interface may be automatically updated to display instructions for returning the undeliverable package to the selected retail store.

### BACKGROUND

Many retailers have online channels for selling inventory items. To fulfill online orders, delivery personnel are required. On occasion, delivery personnel may be unable to complete a delivery to a delivery location due to the delivery location being inaccessible, for example due to a missing gate code, closed office or apartment mailroom, or the like. When a package is undeliverable, a last mile delivery driver may be required to return the undeliverable package to a pickup location, which may be a starting point for the package, or in the case of a large retail enterprise having a multi-level hierarchical supply chain, may be an intermediate sortation point for the package (sometimes referred to herein as a sortation center). However, a pickup location may be a significant distance away from the last mile delivery driver's route, so it may not be feasible or convenient for the driver to return undeliverable packages to such a location. Moreover, in a large retail supply chain, if a delivery driver is required to return an undeliverable package to a sortation center a significant distance away, this may increase delivery costs. Thus, traditional approaches for managing undeliverable packages within the context of such a large supply chain may be limited and costly. It is with respect to these and other general considerations that embodiments have been described.

### SUMMARY

In general, the present disclosure relates to an undeliverable package management system. In a first aspect, example systems for managing an undeliverable package may include a server system implementing an undeliverable package management tool, the server system including a processor and a memory storing instructions which, when executed by the processor, cause the server system to: receive a notification from a delivery driver computing device indicating that a package was undeliverable during a delivery route, wherein the notification includes a delivery driver location at an end of the delivery route; in response to receiving the notification that the package was undeliverable, receive space availability information indicating an amount of space available at a plurality of candidate return locations, the plurality of candidate return locations including one or more retail locations selected from among a plurality of retail store locations, the plurality of candidate return locations being capable of receiving the undeliverable package and including at least one candidate return location that is different from a pickup location of the undeliverable package; access an external data store storing line haul schedule information indicating times at which a line haul will arrive at each of the plurality of candidate return locations to pick up items for transport to a sortation center; based on the delivery driver location, the space availability information, and the line haul schedule information, generate a prioritized list from among the plurality of candidate return locations to which the undeliverable item may be returned; provide, to the delivery driver computing device, the prioritized list for display on a user interface of a mobile application installed thereon; receive, from the delivery driver computing device, a selection of a return location from the prioritized list; and in response to receiving a selection of a return location, automatically generate and send to the delivery driver computing device instructions for returning the undeliverable package to the selected return location.

In a second aspect, example methods for managing an undeliverable package may include receiving a notification from a delivery driver computing device indicating that a package was undeliverable during a delivery route, wherein the notification includes a delivery driver location at an end of the delivery route; in response to receiving the notification that the package was undeliverable, receiving space availability information indicating an amount of space available at a plurality of candidate return locations, the plurality of candidate return locations including one or more retail locations selected from among a plurality of retail store locations, the plurality of candidate return locations being capable of receiving the undeliverable package and including at least one candidate return location that is different from a pickup location of the undeliverable package; accessing an external data store storing line haul schedule information indicating times at which a line haul will arrive at each of the plurality of candidate return locations to pick up items for transport to a sortation center; based on the delivery driver location, the space availability information, and the line haul schedule information, generating a prioritized list from among the plurality of candidate return locations to which the undeliverable item may be returned; providing, to the delivery driver computing device, the prioritized list for display on a user interface of a mobile application installed thereon; receiving, from the delivery driver computing device, a selection of a return location from the prioritized list; and in response to receiving a selection of a return location, automatically generating and sending to the delivery driver computing device instructions for returning the undeliverable package to the selected return location.

In a third aspect, example systems for managing undeliverable packages my include at least one delivery driver computing device including a mobile application installed thereon, the mobile application being configured to generate a user interface presentable to a delivery driver; and a computing system including a database, a processor, and a memory communicatively coupled to the processor, the memory storing instructions executable by the processor to: receive a notification from the delivery driver computing device indicating that a package was undeliverable, wherein the notification includes a delivery driver location; identify a plurality of retail store locations within a predetermined geographic proximity of the delivery driver location; in response to receiving the notification that the package was undeliverable, receive space availability information indicating an amount of space available at a storage locker at the plurality of retail store locations; for each of the plurality of retail store locations, determine whether the retail store location has space to receive the undeliverable package at the storage locker based on the space availability information; access an external data store storing line haul schedule information indicating times at which a line haul will arrive at the plurality of retail store locations to pick up items for transport to a sortation center; for each of the plurality of retail store locations with space to receive the undeliverable package, determine when a line haul is scheduled to pick up items from the retail store location based on the line haul schedule information; based on the determination of whether the retail store locations have space to receive the undeliverable package, the determination of when a line haul is scheduled to pick up items from the retail store locations, and the geographic proximity between the delivery driver's location and the retail store locations, generate a prioritized list of retail store locations to which the undeliverable item may be returned; provide for display on the user interface of the delivery driver computing device, the prioritized list of retail store locations; receive, from the delivery driver computing device, a selection of a retail store location from the prioritized list of retail store locations; in response to receiving a selection of a retail store location, provide instructions to the delivery driver computing device for display on the user interface, the instructions being directions to the delivery driver for returning the undeliverable package to the selected retail store location, wherein the instructions include an access code to access the storage locker; and in response to receiving a notification that the access code was utilized to access the storage locker, automatically updating the space availability information at the selected retail store location.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example network environment where an undeliverable package management system may be implemented.

FIG. 2 illustrates an example flowchart of a method usable by an undeliverable package management system.

FIG. 3 illustrates an example execution of aspects of a method usable by an undeliverable package management system.

FIG. 4 illustrates an example user interface of an undeliverable package management system.

FIG. 5 illustrates an example user interface of an undeliverable package management system.

FIG. 6 illustrates an example user interface of an undeliverable package management system.

FIG. 7 illustrates an example user interface of an undeliverable package management system.

FIG. 8 illustrates an example method useable by an undeliverable package management system.

FIG. 9 illustrates an example method useable by an undeliverable package management system.

FIG. 10 illustrates an example block diagram of a virtual or physical computing system usable to implement aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

As briefly described above, embodiments of the present disclosure relate to an undeliverable package management system that is operable to interact with a delivery driver through a user interface presented on a display of a delivery driver's computing device, such as a mobile phone. The undeliverable package management system may be implemented to encourage return of packages to an alternative location as compared to a pickup location. For example, in a large retail supply chain, a centralized package collection location may be far from a delivery route, but a retail location (e.g., a store) may be closer to the end of a particular driver's delivery route. Accordingly, the undeliverable package management system may be implemented to encourage undeliverable package returns to a store of convenience, as part of a return to store program implemented by a retailer. A delivery driver may be unable to deliver a package to a consumer if, for example, the delivery driver does not have a code to get through a gate to deliver the package within a gated neighborhood, or if the delivery address is an office that is closed for the day. In these instances, the delivery driver may choose to return the undeliverable package to a retail store location, rather than to a location at which the package was picked up by that delivery driver. In examples, the undeliverable package management system may generate and issue a reward to the delivery driver if he or she returns the undeliverable package to a retail store location. The reward may be a monetary reward redeemable for cash or store credit. A rewards program may incentivize last mile delivery drivers to return undeliverable packages to available retail store locations.

If the delivery driver chooses to participate in a return to store program, the delivery driver may utilize a mobile application to send a notification to the undeliverable package management system noting that the package was undeliverable. Using the delivery driver's location, which may be the driver's location at the end of his or her delivery route (as obtained from, for example, GPS data from the mobile device on which the mobile application is installed, or otherwise from an intended end location of the delivery route), the undeliverable package management system may identify a plurality of candidate return locations, within a certain geographic proximity of the delivery driver's location. The return locations may be retail stores. Once nearby retail stores are identified, the undeliverable package management system may receive space availability information indicating whether the retail stores have space to receive the undeliverable package. Based on the identified location, the mobile application may recommend to the driver to return the undeliverable packages to a storage locker outside of the identified retail store, so the space availability information may indicate whether a storage locker has space to receive the undeliverable package. The undeliverable package management system may also receive line haul schedule information from an external database to determine when a line haul is scheduled to pick up items at the retail stores. Based on the line haul information, a determination can be made regarding whether the undeliverable package, if returned to a store, can be picked up by a line haul on the same day as the day the package was identified as being undeliverable.

The retail stores may be prioritized in an ordered list within the mobile application to present to the delivery driver as retail store locations where the undeliverable package may be returned. In some embodiments, a delivery driver may only be presented with retail stores having a line haul scheduled at a time such that the undeliverable package, if returned to the store, can be picked up by the line haul on the same day as the day the package was identified as undeliverable. By returning an undeliverable package to a store that can subsequently get the package on a line haul the same day, the undeliverable package can be returned to a sortation center and delivery may be re-attempted the following day. This minimizes costs associated with delivery logistics and order fulfillment, and minimizes delays in re-attempted delivery by ensuring, at the time of return, that such a timely line haul exists.

Further, the undeliverable package management system can present the prioritized list of retail stores to the delivery driver through an interactive user interface. The delivery driver may be able to select one of the retail stores on the prioritized list to return the undeliverable package to. The user interface may also present instructions for completing the return to store process, including directions to the store, details regarding the package, and details regarding the precise return location (e.g., storage locker number). Additionally, an access code, such as a scannable barcode, may be presented on the user interface and used by the delivery driver to access the return location, such as the storage locker. Once the undeliverable package is returned to the store, store employees may be notified and the undeliverable package may be obtained (e.g., removed from the storage locker) and loaded onto a line haul. The line haul may take the undeliverable package to a sortation center where it can be sorted and prepared for a delivery re-attempt. By directing a delivery driver to return an undeliverable package to a retail store, the efficiency of handling the undeliverable package to get it prepared for another delivery attempt may be improved.

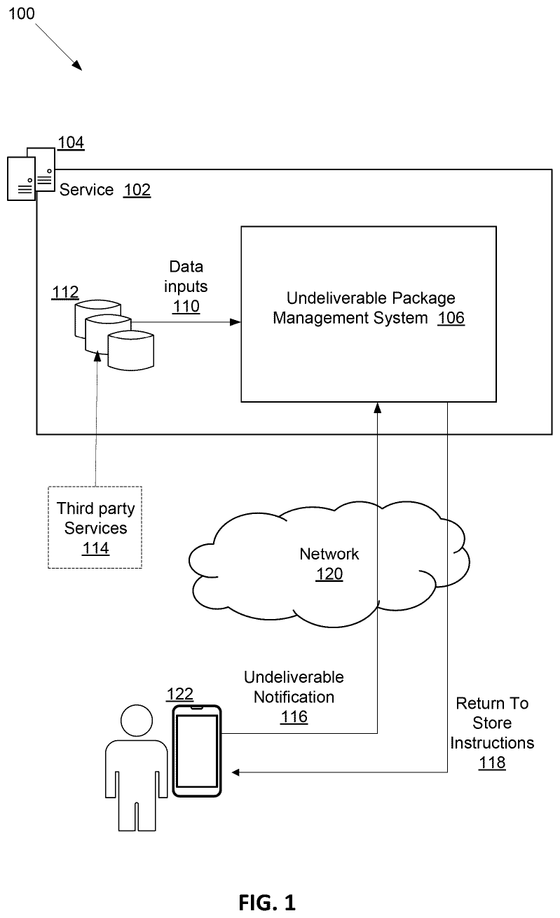

FIG. 1 illustrates an example network environment 100 where a system 106 for managing undeliverable packages may be implemented. The system 106 may be an undeliverable package management system 106 hosted by a service 102. The system 106 may include an undeliverable package management tool. In some examples, the service 102 may be associated with a retailer. The retailer may have at least one or more physical store through which a plurality of inventory items are sold. The retailer may also have an online store in additional to the physical stores, and consumers may be able to place orders through the online store to have inventory items delivered. One or more servers or processors 104 may be operable to execute one or more components of the service 102, including the system.

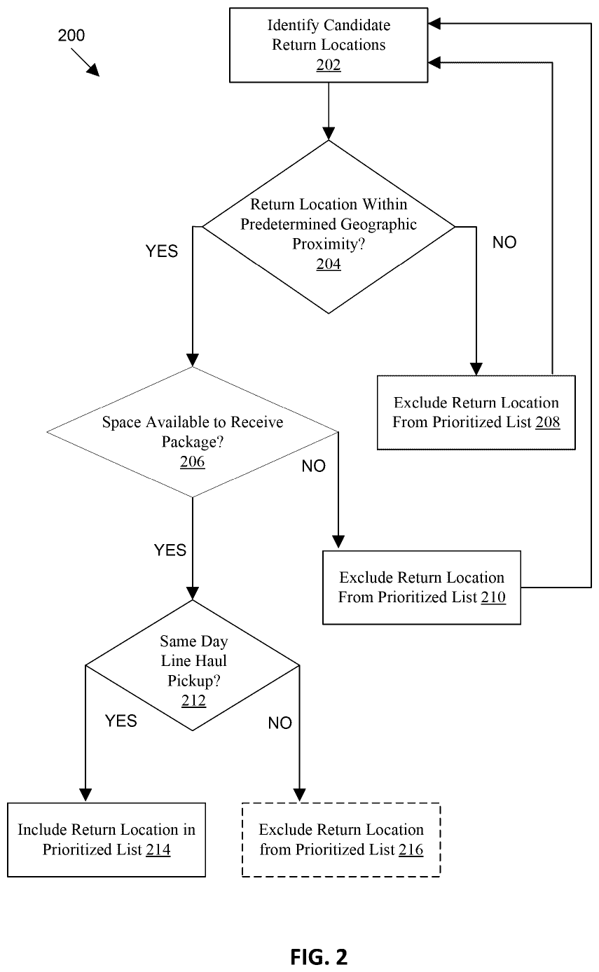

As described in greater detail below, the undeliverable package management system 106 may identify a plurality of retail stores at which an undeliverable package can be returned. Retail stores may be prioritized based on defined variables, parameters, and/or rules. The variables may include geographic distance between a delivery driver and a retail store, whether space is available at the retail store to receive a package, and whether same-day line haul pickup is available at the retail store. A prioritized list of retail stores may be generated. The prioritized list may be an ordered list ranking the retail store locations to which the undeliverable package may be returned, wherein the first retail store on the list is the highest prioritized retail store and the last retail store on the list is the lowest prioritized retail store. The decision-making process for determining whether to include a retail store on the prioritized list of retail stores is described in greater detail with reference to FIG. 2.

If a delivery driver is unable to deliver a package, the driver may send a notification from his or her computing device 122 indicating that the package was undeliverable. In response to the undeliverable package management system 106 receiving a notification 116 that the package was undeliverable, the undeliverable package management system 106 may receive and access data inputs 110 in order to identify possible retail store locations to which the undeliverable package may be returned. The identified retail stores may be subsequently ranked to generate the prioritized list of stores. In some examples, the data inputs may include retail store data (e.g., location, address), space availability information indicating whether retail stores have space to receive an undeliverable package, and line haul schedule information indicating times at which a line haul will pick up items at the retail stores. Some of the data inputs 110 may be generated internally by the service 102 and subsequently stored in the data stores 112. In other examples, one or more of the data inputs 110 may be generated externally by third party services 114 and provided to the service 102 for storage in the data stores. The data inputs 110 may further include parameters or rules associated with a return-to-store program for managing undeliverable packages. Example rules may include a maximum geographic distance that the delivery driver may travel to return an undeliverable package to a store (e.g., 10 miles, 20 miles), and whether the undeliverable package must be returned to a store with same-day line haul pickup available. The parameters or rules may be determined by the retailer managing a return to store program and received by the undeliverable package management system 106 from a retailer computing device. In some examples, each type of data may be stored in separate data stores 112. In other examples, the various types of data may be combined in one or more of the data stores 112.

Once the system 106 utilizes the data inputs to generate a prioritized list of retail stores to which the undeliverable package may be returned, the prioritized list of stores may be provided to the delivery driver computing device 122 over a network 120 along with instructions 118 for returning the undeliverable package. The delivery driver computing device 1222 may be a portable computing device such as a tablet computer or a mobile phone. In examples, the delivery driver may receive the return to store instructions 118 through a display on a user interface presented on the delivery driver's computing device 122.

FIG. 2 illustrates an example flowchart of a method 200 usable by an undeliverable package management system. The method 200 is usable to determine whether a return location should be included on a prioritized list of return locations to present to a delivery driver as locations to which the undeliverable package may be returned. When the undeliverable package management system receives a notification from a delivery driver computing device that a package was undeliverable on a delivery route, the undeliverable package management system may identify a plurality of candidate return locations (step 202) to which the package may be returned. The identified candidate return locations may include all retail stores within a predetermined geographic proximity of the delivery driver's location, or a subset of retail stores within a predetermined geographic proximity of the delivery driver's location if not all of the retail stores are participating in a return to store program. For example, a rule associated with a return to store program may establish that the delivery driver may not travel more than 15 miles from his or her location at the end of the delivery route to return the package to a store. Thus, when a return location is identified, the undeliverable package management system may determine whether the return location is within a predetermined geographic proximity (step 204) established by a return to store program rule. If the return location is not within the predetermined geographic proximity, it may be excluded from the prioritized list (e.g., taking the “NO” branch from step 204 to step 208). If the return location is within the predetermined geographic proximity, it may remain in consideration for inclusion on the prioritized list (e.g., taking the “YES” branch from step 204 to step 206).

At step 206, undeliverable package management system may determine if return locations within the predetermined geographic proximity have space available to receive the undeliverable package. Determining whether there is space available to receive the undeliverable package may include receiving and analyzing space availability information associated with the return locations. In examples, storage lockers may be located inside or outside of retail stores and be configured to receive undeliverable packages. The storage lockers may have a plurality of individual lockers, wherein each locker is configured to receive a single package or multiple packages. Thus, the space availability information may indicate whether a return location has space within a storage locker to receive the undeliverable package. If the return location does not have space available to receive the undeliverable package, the return location may be excluded from the prioritized list (e.g., taking the “NO” branch from step 206 to step 210). If the return location does have space available to receive the undeliverable package, the return location may remain in consideration for inclusion on the prioritized list (e.g., taking the “YES” branch from step 206 to step 212).

At step 212, the undeliverable package management system may determine if return locations with space available to receive the undeliverable package have a line haul scheduled to pick up items at a time such that the undeliverable package, if returned to the return location, can be picked up by a line haul on the same day that it was undeliverable. Determining whether a line haul is scheduled to enable same-day pick up may include accessing and analyzing line haul schedule information to determine times at which line hauls are scheduled to pick up items at the return locations, including retail stores. In some examples, a return to store program rule may establish that the prioritized list may only include return locations that have same-day line haul pickup available. In these examples, if a line haul pickup is not available on the same day, the return location may be excluded from the prioritized list (e.g., taking the “NO” branch from step 212 to step 216). In these examples, if line haul pickup is available on the same day, the return location may be included in the prioritized list (e.g., taking the “YES” branch from step 212 to step 214). In other examples, the return to store program may not establish a rule requiring that all retail stores on the prioritized list have same day line haul pickup available. In these examples, the return locations that do not have same day line haul pickup available may still be included on the prioritized list, but they may be prioritized lower than return locations having same day pickup available.

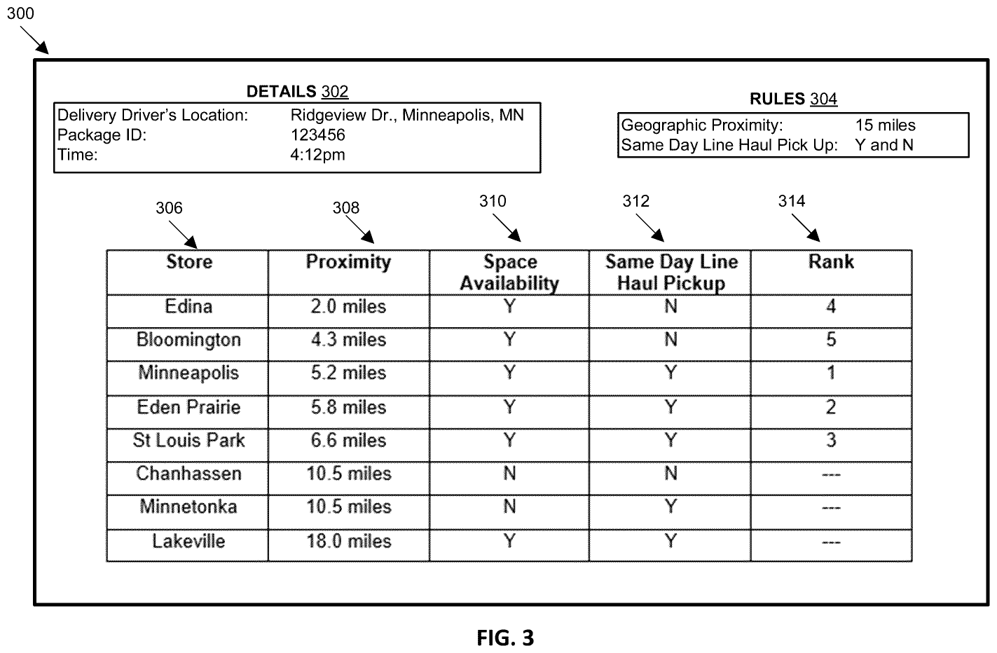

FIG. 3 illustrates an example execution 300 of aspects of the method 200 usable by an undeliverable package management system. The undeliverable package management system may receive details 302 regarding the undeliverable package when the undeliverable package notification is received. The details 302 may include the delivery driver's location, which may be the driver's location at the end of his or her route, a package identifier number, and a time, which may be the time at which delivery was attempted and undeliverable or the time at the end of the delivery driver's route. The undeliverable package management system may also receive rules 304 associated with a return to store program. The rules 304 may define a maximum geographic proximity indicating the distance a delivery driver may travel to return an undeliverable package to a store (e.g., 15 miles). The rules 304 may further include an indication of whether the delivery driver must return the undeliverable package to a store with same day line haul pickup available. Based on data inputs and information contained within the undeliverable package notification received from the delivery driver's computing device, the undeliverable package management system may execute the method 200 illustrated in FIG. 2 to identify and rank retail store locations in order to generate a prioritized list of retail stores to provide to the delivery driver.

The undeliverable package management system may identify a list of stores 306. Using store information and the delivery driver's location, the undeliverable package management system may determine the proximity 308 of each store to the delivery driver's location. The proximity information may be either a distance (e.g., miles) or a time (e.g., minutes). Using the space availability information, the undeliverable package management system may determine whether each retail store has space available 310 to receive the undeliverable package (e.g., “Y” for yes space is available, “N” for no space available). Using the line haul scheduling information, the undeliverable package management system may determine whether same day line haul pickup is available 314 (e.g., “Y” for same day line haul pickup is available, “N” for same day line haul pickup is not available). The undeliverable package management system may then automatically exclude any retail stores that are not within the predetermined geographic proximity established by the rules 304. In the example shown in FIG. 3, the Lakeville store is located 18 miles away from the delivery driver, which is outside of the 15-mile predetermined geographic proximity, so the Lakeville store is automatically excluded from the prioritized list of retail stores. This is shown in the rank column 314 indicated by the dashed line. The undeliverable package management system may also automatically exclude any retail stores that do not have space to receive the undeliverable package. In the example shown in FIG. 3, the Chanhassen store and the Minnetonka store do not have space available to receive the undeliverable package, so these two stores are automatically excluded from the prioritized list of retail stores. This is shown in the rank column 314 indicated by the dashed line.

After excluding retail stores that are not within the predetermined geographic proximity and that do not have space to receive the undeliverable package, the undeliverable package management system may use the same day line haul pickup information 312 to group the remaining retail stores into two groups: a first group being the retail stores with same day line haul pickup available and a second group being the retail stores without same day line haul pickup available. If retail stores without same day line haul pickup available are not permitted per the rules 304, then the retail stores in the second group will also be excluded from the prioritized list of retail stores. In these examples, the retail stores in the first group may then be ranked based on proximity, with the store closest to the delivery driver having the highest priority and the store furthest from the delivery driver having the lowest priority. If retail stores without same day line haul pickup available are permitted per the rules 304, such as in the example shown in FIG. 3, then the retail stores within both the first and second group may be ranked based on proximity. After ranking the retail stores within both groups based on priority, an overall ranking can be established wherein the retail stores in the first group are ranked higher than the retail stores in the second group.

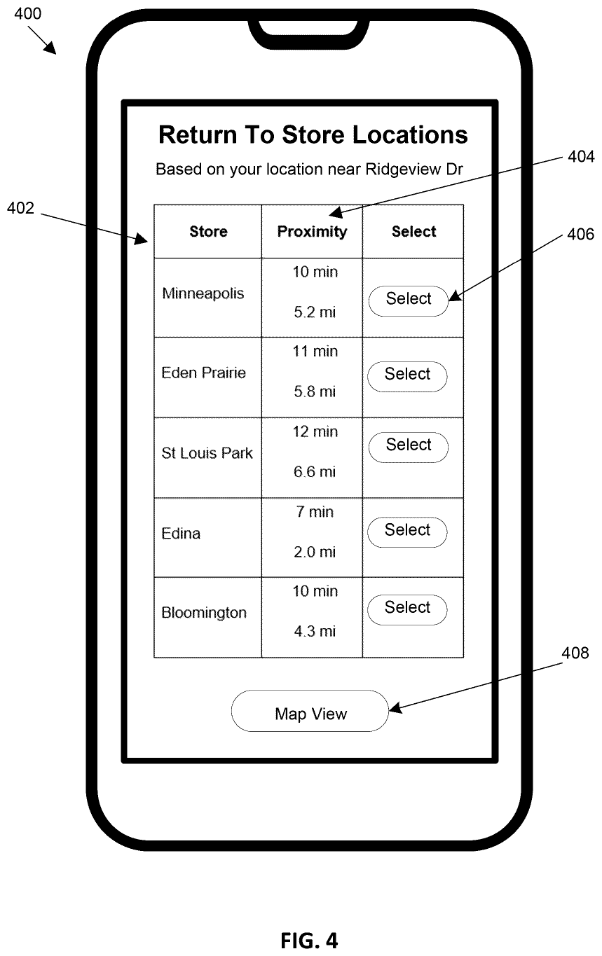

For example, as illustrated in FIG. 3, the Minneapolis store, Eden Prairie store, and St. Louis Park store have same day line haul pickup available, so those three retail store locations comprise a first group. Ranking those three stores by proximity results in the following ranking from highest priority to lowest priority: Minneapolis, Eden Prairie, St. Louis Park. The Edina store and the Bloomington store do not have same day line haul pickup available, so those two retail store locations comprise the second group. Ranking those two stores by proximity results in the following ranking from highest priority to lowest priority: Edina, Bloomington. An overall ranking can then be determined, wherein all the stores in the first group are ranked higher than all the stores in the second group because stores with same day line haul pickup are preferred. Thus, the overall ranking from highest priority to lowest priority becomes: Minneapolis, Eden Prairie, St. Louis Park, Edina, Bloomington. This prioritized list, which includes an ordered list of retail stores ranked from highest priority to lowest priority, may then be presented to the delivery driver and displayed on a user interface, such as the user interface depicted in FIG. 4.

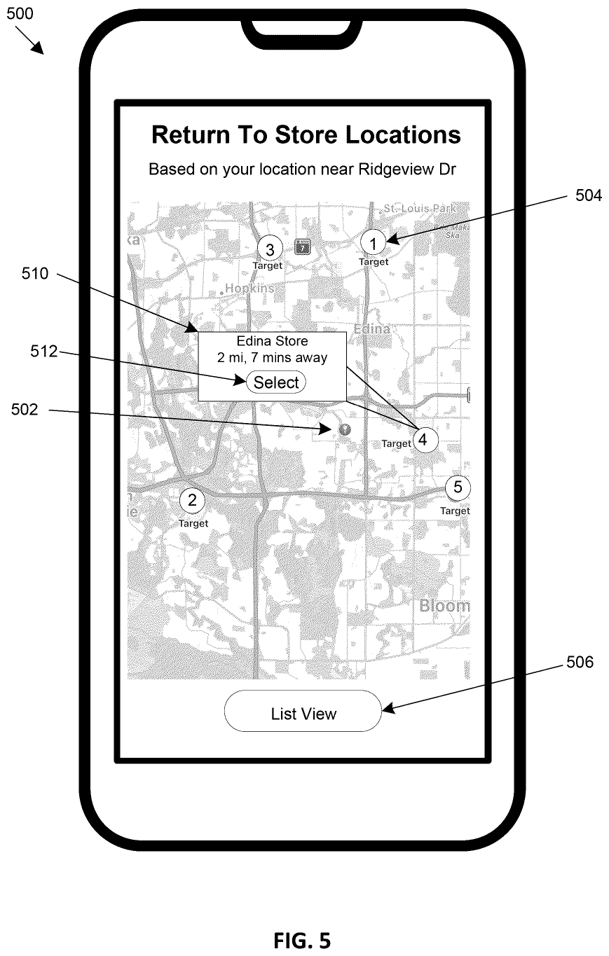

FIG. 4 illustrates an example user interface 400 of an undeliverable package management system. The prioritized list of retail stores, such as the example prioritized list described with respect to FIG. 3, may be presented to a delivery driver and displayed on a user interface 400. The user interface 400 may include the prioritized list 402, wherein the retail stores are listed in order of highest ranking to lowest ranking retail stores as determined by the undeliverable package management system. In examples, the delivery driver may wish to view the retail stores on the prioritized list in a map format. Therefore, the user interface 400 may include a selectable element 408 to switch the view of the prioritized list from a list view to a map view. A user interface having a map view of the prioritized list of retail stores is described in greater detail with reference to FIG. 5. Proximity information 404 associated with each retail store on the prioritized list 402 may also be presented.

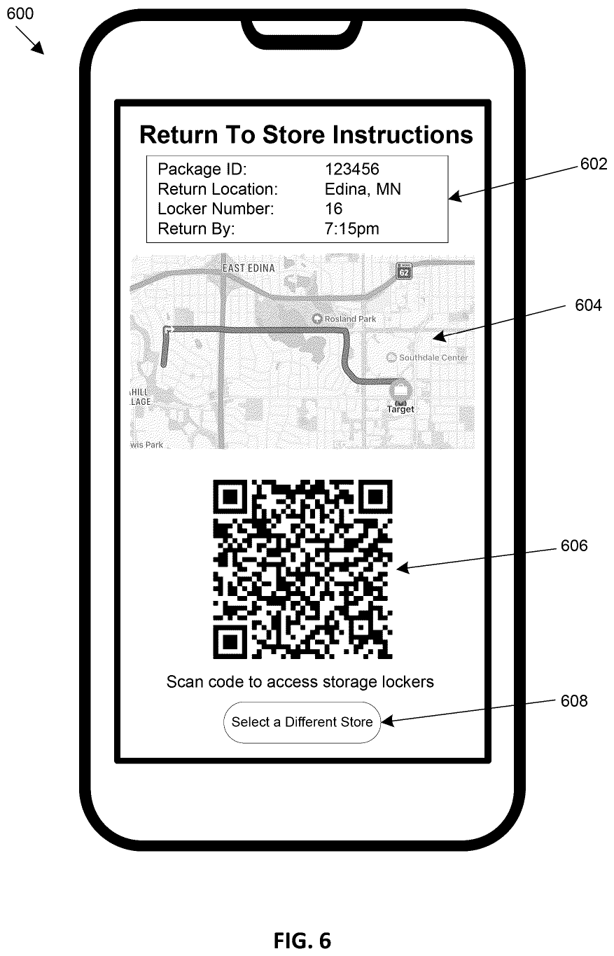

The user interface 400 may further include a selectable element 406 associated with each retail store on the prioritized list 402. The selectable element may be a selectable button. Thus, the delivery driver may select which retail store on the prioritized list 402 he or she will return the undeliverable package to by clicking the selectable element associated with one of the retail stores. When the delivery driver selects a retail store by clicking a selectable element associated with one of the retail stores, undeliverable package management system receives, from the delivery driver computing device, the selection of a retail store location from the prioritized list of store locations. The undeliverable package management system may then provide instructions to the delivery driver for returning the undeliverable package to the selected retail store. The instructions may be presented to the delivery driver and displayed on a user interface, such as the user interface depicted in FIG. 6.

FIG. 5 illustrates another example user interface 500 of an undeliverable package management system. In examples, the prioritized list of retail store may be displayed on a user interface 500 in a map view. The map view may be the default view, or the map view may be presented on the user interface 500 in response to a selection made by the delivery driver to view the prioritized list of stores in a map view instead of in a list view. If the map view is displayed, the user interface 500 may include a selectable element 506 to present the prioritized list of stores in a list view. When the prioritized list is presented in a map view, a map may be displayed that indicates the delivery driver's location 502, and the location of each retail store on the prioritized list. Each retail store on the prioritized list may appear on the list and include a priority ranking 504. In examples, the delivery driver may click on one of the store locations and in response to the delivery driver clicking on a store location, a pop-up window 510 may be displayed on the user interface 500 providing additional details for the store that was clicked on. The additional details in the pop-up window 510 may include the store location, the proximity from the store, and a selectable element 512 to select the retail store as the location to return the undeliverable package to. If the delivery driver wishes to return the undeliverable package to the store displayed in the pop-up window 510, the delivery driver may select the selectable element 512. In other examples, if a delivery driver clicks on a store location, this may indicate to the undeliverable package management system that the delivery driver has selected that store location to return the undeliverable package to. Once the undeliverable package management system has received a selection of a retail store from the delivery driver through the user interface, the undeliverable package management system may then provide instructions to the delivery driver for returning the undeliverable package to the selected retail store. The instructions may be presented to the delivery driver and displayed on a user interface, such as the user interface depicted in FIG. 6.

FIG. 6 illustrates another example user interface of an undeliverable package management system. In examples, instructions for returning an undeliverable package to the retail store selected by the delivery driver may be presented on a user interface 600. The instructions may include a details window 602 containing details regarding the undeliverable package and the return location. For example, the details window 602 may include a unique identifier to identify the undeliverable package, the location to which the undeliverable package will be returned, a locker number if the undeliverable package is being returned to a storage locker, and a return by time. The return by time may be provided to ensure that the undeliverable package is returned to the storage locker in time for the undeliverable package to be loaded onto a line haul. The instructions may further include a map 604 and/or directions from the delivery driver's location to the selected retail store. In examples, the directions may be specific to the precise location of a storage locker associated with the selected retail store, rather than the retail store itself.

The user interface 600 may further include an access code 606 that may be used by the delivery driver to access a storage locker or other container where the undeliverable package will be received at the selected retail store. The storage locker or container may be configured with a keypad, barcode reader, or other lock system that can receive the access code in order to be unlocked or opened. In examples, the access code may be a scannable barcode. In other examples, the access code may be a numeric code or letter code which the delivery driver may enter on a keypad or other lock device or system to open the storage locker or container. The storage locker or container where the undeliverable package will be received may be within a secured area, such as within a gated or fenced-in area. In these instances, there may be a keypad, lock device or system, or a barcode reader at which the delivery driver may enter or scan the access code to gain access to the secured location to return the undeliverable package. In other examples, the storage locker or container may not be secured behind a gate or fence or the like, and the delivery driver may simply drive up to the storage locker or container. The access code may be required to open the storage locker or container. In examples, if a storage locker is utilized to receive the undeliverable package, entering or scanning the access code may open the specific locker that the package should be placed in (e.g., Locker No. 16). In examples where a storage locker or container is within a restricted area, a single access code may give the delivery driver access to the secured area and enable the delivery driver to open the storage locker. Alternatively, the delivery driver may be presented with two access codes: one to access the secured area where the storage locker or container is located and one to open the storage locker or container.

When the access code is utilized (e.g., entered or scanned), the undeliverable package management system may receive a notification that the undeliverable package has been returned to the retail store selected by the delivery driver. In response to receiving the notification, the undeliverable package management system may automatically update the space availability information to reflect that the undeliverable package has been returned and taken up space at the selected retail store location (e.g., one less locker is available to receive an undeliverable package). Moreover, in examples, the space availability information may be automatically updated as soon as a delivery driver has selected a retail location to return the undeliverable package to. Thus, the system may assume that space will be taken up in a storage locker or other container as soon as the driver has selected a retail store, but before the undeliverable package is actually placed in the locker or container. This avoids the possibility that two delivery drivers proceed to the same retail store location at a similar time with instructions to place the undeliverable packages in the same locker number. In response to receiving the notification, the undeliverable package management system may be further configured to send a confirmation message to a retailer computing device indicating that the undeliverable package has been returned to the selected retail store and providing instructions to unload the undeliverable package from the storage locker to a line haul. By sending a confirmation message to the retailer as soon as the undeliverable package has been returned to the store, a retail employee may be able to quickly unload the undeliverable package from the storage locker to a line haul to ensure that the package is picked up by a line haul as soon as possible. In some examples, a retail employee may be able to unload the undeliverable package from the storage locker to a line haul so that the undeliverable package is picked up by a line haul on the same day that it was returned to the store. In these examples, the undeliverable package may ultimately be returned to a sortation center on the same day it was undeliverable, and subsequently prepared for another delivery attempt on the following day.

The user interface 600 may also display a selectable element 608 such as a button to allow the delivery driver to go back and select a different retail store. For example, if the delivery driver views the instructions presented on the user interface 600 and realizes he or she intended to select a different retail store, or that the selected retail store requires an unfavorable route (e.g., due to traffic, construction), the delivery driver may click the selectable element 608 and return to the prioritized list of retail stores as displayed in the list view, illustrated in FIG. 4, or the map view, illustrated in FIG. 5.

In examples, when the access code is utilized to return the undeliverable package to the selected retail store, a message may be sent to a customer computing device providing the customer with an option to switch from delivery to a pickup option for the undeliverable package. If the customer selects the pickup option, he or she may be provided with instructions for picking up the undeliverable package at the retail store location where the package was returned. This delivery option message may be sent to the customer computing device automatically after the access code is utilized to return the undeliverable package, or after the retailer approves the delivery option message.

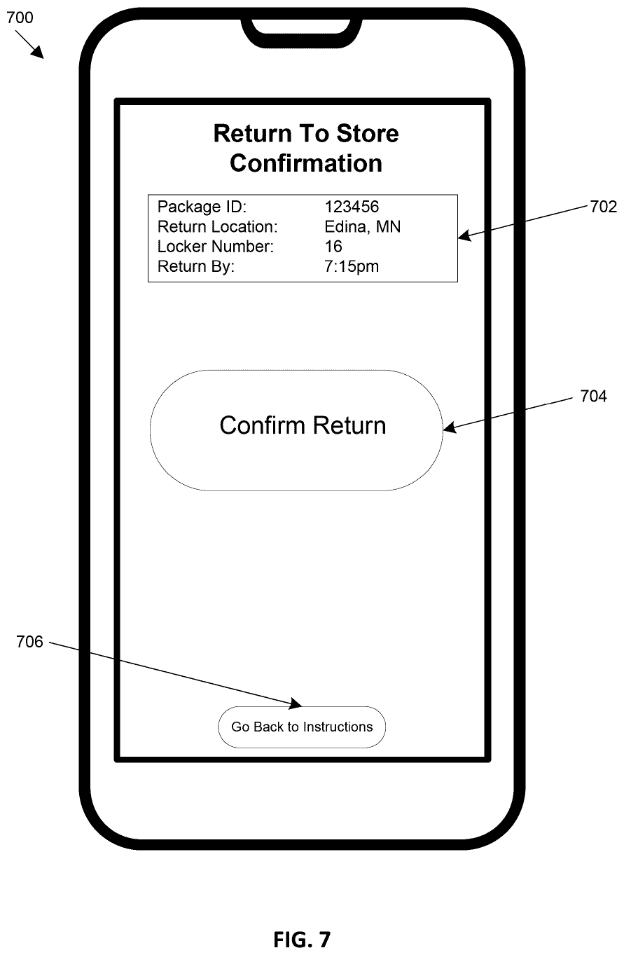

FIG. 7 illustrates another example user interface 700 of an undeliverable package management system. In some examples, after the undeliverable package management system has received a notification that the access code was utilized at the selected retail store location, a confirmation page may be automatically displayed and presented to the delivery driver on a user interface 700. The user interface 700 presenting the confirmation page may include a details window 702 containing details regarding the undeliverable package and the return location. The user interface 700 may further include a selectable confirmation element 704. In examples where a selectable confirmation element 704 is presented on the delivery driver computing device via the user interface 700, the delivery driver may select or click on the selectable confirmation element 704 to confirm that the undeliverable package has been returned to the selected retail store location. The undeliverable package management system may receive the selection of the confirmation element 704 and in response to the selection determine that the undeliverable package has been returned to the selected retail store and the return has been confirmed by the delivery driver. In some examples, the space availability information may not be automatically updated until the return has been confirmed by the delivery driver. Similarly, in some examples, a confirmation message may not be sent to a retailer computing device indicating that the undeliverable package has been returned to the selected retail store and providing instructions to unload the undeliverable package from the storage locker to a line haul until the return has been confirmed by the delivery driver. In some examples, a delivery option message may not be sent to the customer computing device with an option to switch from delivery to pickup until the return has been confirmed by the delivery driver. The user interface 700 may also include a selectable element 706 to go back to the return to store instructions screen, as described with reference to FIG. 6.

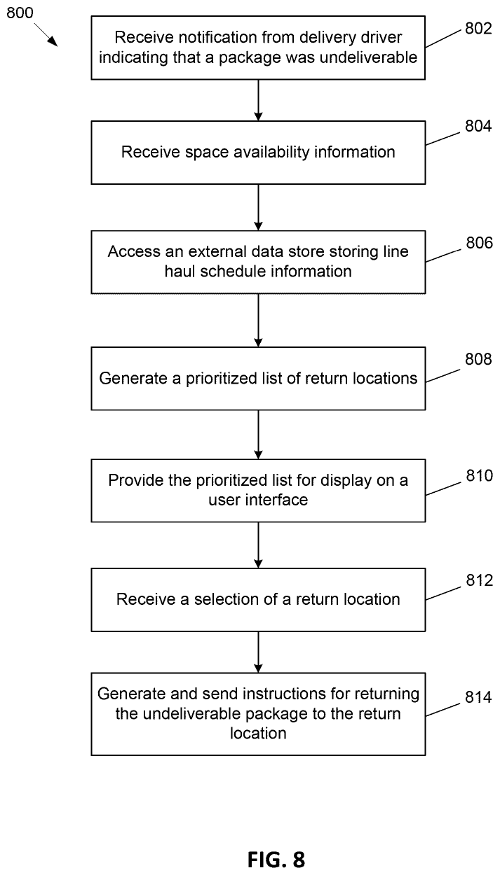

FIG. 8 illustrates an example method 800 useable by an undeliverable package management system. In some examples, the method 800 may be performed by the undeliverable package management system 106 described in detail with reference to FIG. 1.

The method 800 begins at step 802, where a notification is received by the undeliverable package management system from a delivery driver computing device indicating that a package was undeliverable during a delivery route. The notification may include a delivery driver's location, which may be the delivery driver's location at the end of a delivery route. In examples, the delivery driver may send a first notification to the undeliverable package management indicating that the package was undeliverable at the time the package could not be delivered (e.g., in the middle of the delivery route), and a second notification indicating his or her location at the end of the delivery route. In response to receiving the notification that the package was undeliverable, at step 804, the undeliverable package management system may receive space availability information indicating an amount of space available at a plurality of candidate return locations to receive the undeliverable package. The plurality of candidate return locations may be a plurality of retail store locations, which may be all of the retail store locations within a predetermined distance of the delivery driver's location at the end of the delivery route, and the predetermined distance may be a rule or parameter established by a retailer managing a return to store program. In examples, the candidate return locations may include any sortation centers within the predetermined geographic proximity. The space availability information may correspond to the amount of space available in a storage locker or other container at the retail store locations, and it may indicate whether a storage locker or other container is full or whether it has space to receive an undeliverable package. At step 806, the undeliverable package management system may access an external data store storing line haul schedule information indicating times at which a line haul will arrive at the plurality of retail store locations to pick up items for transport to a sortation center. By accessing line haul schedule information, the undeliverable package management system may determine whether, if the undeliverable package is return to a store, the undeliverable package can be picked up by a line haul on the same day as the day it was undeliverable by the delivery driver.

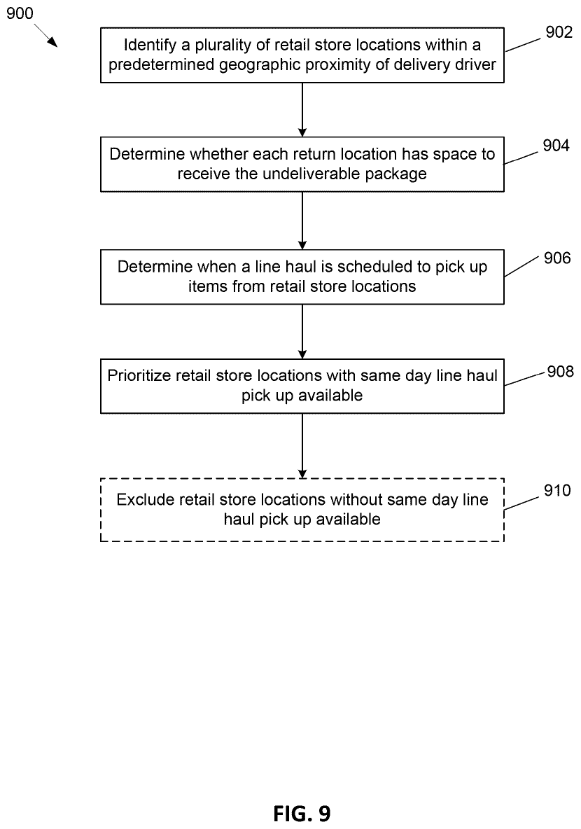

Once the undeliverable package management system has the delivery driver's location, space availability information, and line haul schedule information, the undeliverable package management system may generate a prioritized list of return locations to which the undeliverable item may be returned at step 808, wherein the prioritized list is based on the delivery driver's location, space availability information, and line haul schedule information. The method by which the undeliverable package management system generates the prioritized list is described in further detail below with reference to FIG. 9. The prioritized list may then be provided to the delivery driver computing device for display on a user interface of a mobile application installed thereon at step 810. The prioritized list may be displayed in a list view, such as in the user interface 400 illustrated in FIG. 4, or in a map view, such as in the user interface 500 illustrated in FIG. 5.

At step 812, the undeliverable package management system may receive a selection of a return location from the prioritized list from the delivery driver computing device. The selection of the return location may indicate which return location the delivery driver will return the undeliverable package to. In examples, the selected return location may be a sortation center. In response to receiving the selection of a return location from the delivery driver computing device, at step 814, the undeliverable package management system may automatically generate and send to the delivery driver computing device instructions for returning the undeliverable package to the selected return location. The display of the instructions is described in more detail with reference to the user interface 600 illustrated in FIG. 6. The instructions may include an access code to access a storage locker or container that will receive the undeliverable package at the selected retail store.

In examples, if the undeliverable package management system receives a notification that the access code was utilized to return the undeliverable package to the selected return location, the undeliverable package management system may automatically update the space availability information in real time to reflect that the undeliverable package has taken up a space at the selected return location. Moreover, as discussed above the space availability information may be automatically updated as soon as a delivery driver has selected a return location to return the undeliverable package to. In further examples, if the undeliverable package management system receives a notification that the access code was utilized to return the undeliverable package to the selected return location, the undeliverable package management system may send a confirmation message to a retailer computing device indicating that the undeliverable package has been returned to the return location and providing instructions to unload the undeliverable package from the storage locker to a line haul.

FIG. 9 illustrates another example method 900 useable by an undeliverable package management system. In some examples, the method 900 may be performed by the undeliverable package management system 106 described in detail with reference to FIG. 1.

The method 900 may be performed by the undeliverable package management system to generate a prioritized list of return locations to which the undeliverable item may be returned, as described at step 808 of method 800, illustrated in FIG. 8. To generate the prioritized list, the undeliverable package management system may first identify, as the plurality of candidate return locations, a plurality of retail store locations within a predetermined geographic proximity of the delivery driver's location at step 902. The predetermined geographic proximity (e.g., 10 miles from the delivery driver's location, 20 miles from the delivery driver's location) may be determined by a retailer managing a return to store program. At step 904, for each of the plurality of return locations identified at step 902, the undeliverable package management system may determine whether the return location has space to receive the undeliverable package based on the space availability information. If a return location does not have space to receive the undeliverable package, it may be excluded from the prioritized list of retail store locations. At step 906, for each of the plurality of return locations with space to receive the undeliverable package that is a retail store location, as determined at step 904, the undeliverable package management system may determine when a line haul is scheduled to pick up items from the retail store location based on the line haul schedule information. The determination at step 906 may further include determining whether the undeliverable package, if returned to a retail store location, can be picked up by a line haul on the same day as the day it was undeliverable by the delivery driver. The undeliverable package management system may then prioritize, at step 908, the retail store locations that have same day line haul pickup available for the undeliverable package. The prioritization at step 908 may include grouping the retail stores into two groups—a first group including the retail store locations that have same day line haul pickup available and the second group including the retail store locations that do not have same day line haul pickup available—and prioritizing the retail stores in the first group ahead of the retail stores in the second group. The retail stores may be further prioritized, within their respective groups, based on geographic proximity to the delivery driver's location. In some examples, if the retailer has established a rule requiring that all retail stores on the prioritized list of retail stores presented to the delivery driver have same day line haul pickup available, the retail store locations without same day line haul pickup available may be excluded from the prioritized list at step 910. Once the prioritized list of retail store locations is generated, it may be displayed on a user interface presented on the delivery driver computing device, as described in method 800 at step 810, illustrated in FIG. 8.

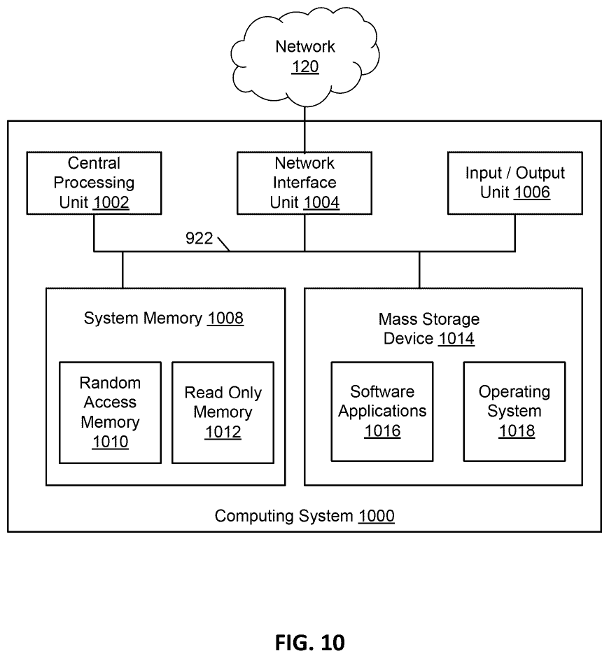

FIG. 10 illustrates an example block diagram of a virtual or physical computing system 1000. One or more aspects of the computing system 1000 can be used to implement the undeliverable package management system 106, retail server service 102, or other computing systems described above in conjunction with FIG. 1.

In the embodiment shown, the computing system 1000 includes one or more processors 1002, a system memory 1008, and a system bus 1022 that couples the system memory 1008 to the one or more processors 1002. The system memory 1008 includes RAM (Random Access Memory) 1010 and ROM (Read-Only Memory) 1012. A basic input/output system that contains the basic routines that help to transfer information between elements within the computing system 1000, such as during startup, is stored in the ROM 1012. The computing system 1000 further includes a mass storage device 1014. The mass storage device 1014 is able to store software instructions and data. The one or more processors 1002 can be one or more central processing units or other processors.

The mass storage device 1014 is connected to the one or more processors 1002 through a mass storage controller (not shown) connected to the system bus 1022. The mass storage device 1014 and its associated computer-readable data storage media provide non-volatile, non-transitory storage for the computing system 1000. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1000.

According to various embodiments of the invention, the computing system 1000 may operate in a networked environment using logical connections to remote network devices through the network 1020. The network 1020 is a computer network, such as an enterprise intranet and/or the Internet. The network 1020 can include a LAN, a Wide Area Network (WAN), the Internet, wireless transmission mediums, wired transmission mediums, other networks, and combinations thereof. The computing system 1000 may connect to the network 1020 through a network interface unit 1004 connected to the system bus 1022. It should be appreciated that the network interface unit 1004 may also be utilized to connect to other types of networks and remote computing systems. The computing system 1000 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the computing system 1000 can store software instructions and data. The software instructions include an operating system 1018 suitable for controlling the operation of the computing system 1000. The mass storage device 1014 and/or the RAM 1010 also store software instructions, that when executed by the one or more processors 1002, cause one or more of the systems, devices, or components described herein to provide functionality described herein. For example, the mass storage device 1014 and/or the RAM 1010 can store software instructions that, when executed by the one or more processors 1002, cause the computing system 1000 to receive and execute managing network access control and build system processes.

In accordance with the present disclosure, and as reflected in the embodiments below, the present undeliverable package management system has a number of technical advantages over existing systems. In particular, referring to FIGS. 1-10 overall, the undeliverable package management system provides an advantageous tool for efficient management of undeliverable packages in order to quickly and efficiently re-insert undeliverable packages into a delivery network such that another delivery attempt can be made as soon as possible. Traditional systems for managing undeliverable packages may require delivery drivers to return undeliverable packages to sortation centers. However, the nearest sortation center to a delivery driver's route may be a significant distance away, so it is not realistic to expect a delivery driver to return an undeliverable package to the nearest sortation center. Thus, undeliverable packages may not get returned, or, if deliver drivers are required to return packages to sortation centers, delivery driver retention may drop as delivery drivers are inconvenienced with driving long distances at the end of a delivery route to return packages to sortation centers. Moreover, if deliver drivers are required to return packages to sortation centers that are located far away, this may increase delivery costs for a retailer. Typically, a geographic area will have many more retail stores than sortation centers, and there may be retail stores only be a few miles away from a delivery driver. Therefore, if retail stores are configured to receive undeliverable packages, delivery drivers may return undeliverable packages to retail stores, which may be significantly closer and more convenient than driving to a sortation center far away to return an undeliverable package.

The undeliverable package management system described above is an advantageous tool for effectively managing the return of undeliverable packages to retail store locations. For example, the undeliverable package management system is configured to consider a plurality of rules and parameters to generate a prioritized list of retail store locations to which the delivery driver may return the undeliverable package. The undeliverable package management system uses a decision-making process that incorporates rules of a return to store program as established by the retailer and inputs from data stores to provide delivery drivers with flexible options for selecting a return location. In addition to considering ease and convenience of the delivery driver when generating a prioritized list of retail store locations, the undeliverable package management system further considers the cost benefits for the retailer if the undeliverable package can be quickly returned to a sortation center on the same day the package was undeliverable and then out for another delivery attempt the following day. Thus, the undeliverable package management system may prioritize retail store locations with same day line haul pick up, even if those retail store locations are further away from the delivery driver's location. The undeliverable package management system permits an earlier second attempt at delivering the package while also improving delivery driver experience. Additionally, the undeliverable package management system may comprise an automatic feedback dataflow configured to automatically update space availability information in real time used to generate the prioritized list of retail store locations. Thus, as packages are returned to retail stores and picked up by line hauls, the automatic feedback dataflow will dynamically update the space availability information to accurately reflect whether a retail store location has space to receive an undeliverable package. Having accurate and up-to-date space availability information will improve the return to store program and ensure that the undeliverable package management system does not, for example, send a delivery driver to a storage locker than has just been filled by another undeliverable package.

In addition, the undeliverable package management system includes an improved interactive user interface configured to interact with a delivery driver. The user interface may improve delivery driver convenience and efficiency by simplifying the process for managing undeliverable packages. Specifically, the user interface may present the delivery driver with available return to store locations, giving the driver flexible options to choose from. The user interface may be automatically updated once the driver selects a return location to provide the driver with precise instructions for returning the package (e.g., return details, directions). An access code presented on the user interface gives the delivery driver an easy method to access a return storage locker or container. Additionally, in examples, the return storage locker or container may be located outside of a retail store location such that the delivery driver can simply drive up to the return storage locker or container and return the undeliverable package without having to exit the vehicle. The undeliverable package management system may be integrated within a larger logistics operation of a retailer and configured to interact with other systems and tools involved with delivery and order fulfillment.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. An undeliverable package management system comprising,
a server system implementing an undeliverable package management tool, the server system including a processor and a memory storing instructions which, when executed by the processor, cause the server system to:
receive a notification from a delivery driver computing device indicating that a package was undeliverable during a delivery route, wherein the notification includes a delivery driver location at an end of the delivery route;
in response to receiving the notification that the package was undeliverable, receive space availability information indicating an amount of space available at a plurality of candidate return locations, the plurality of candidate return locations including one or more retail locations selected from among a plurality of retail store locations, the plurality of candidate return locations being capable of receiving the undeliverable package and including at least one candidate return location that is different from a pickup location of the undeliverable package;
access an external data store storing line haul schedule information indicating times at which a line haul will arrive at each of the plurality of candidate return locations to pick up items for transport to a sortation center;
based on the delivery driver location, the space availability information, and the line haul schedule information, generate a prioritized list from among the plurality of candidate return locations to which the undeliverable item may be returned;
provide, to the delivery driver computing device, the prioritized list for display on a user interface of a mobile application installed thereon;
receive, from the delivery driver computing device, a selection of a return location from the prioritized list; and
in response to receiving a selection of a return location, automatically generate and send to the delivery driver computing device instructions for returning the undeliverable package to the selected return location.

2. The undeliverable package management system of claim 1, further comprising the delivery driver computing device, wherein the delivery driver computing device has a mobile application installed thereon, the mobile application being configured to display the prioritized list and the instructions for returning the undeliverable package to the selected return location.

3. The undeliverable package management system of claim 1, further comprising a plurality of delivery driver computing devices, each being associated with a different delivery driver of a plurality of delivery drivers.

4. The undeliverable package management system of claim 1, wherein the plurality of candidate return locations includes a sortation center, the sortation center being the pickup location of the undeliverable package.

5. The undeliverable package management system of claim 1, wherein to generate the prioritized list, the instructions, when executed, further cause the system to:
identify, as the plurality of candidate return locations, a plurality of retail store locations within a predetermined geographic proximity of the delivery driver's location;
for each of the plurality of candidate return locations, determine whether the candidate return location has space to receive the undeliverable package based on the space availability information;
for each of the candidate return locations with space to receive the undeliverable package that is a retail store location, determine when a line haul is scheduled to pick up items from the retail store location based on the line haul schedule information; and
prioritize, among the plurality of candidate return locations, any retail store location with a line haul scheduled at a time such that the undeliverable package, if returned to the store, can be picked up by the line haul on the same day as the day the package was undeliverable.

6. The undeliverable package management system of claim 1, wherein the candidate return locations on the prioritized list are prioritized first based on whether a line haul is scheduled at a time such that the undeliverable package, if returned to the retail store location, can be picked up by the line haul on the same day as the day the package was undeliverable and second based on geographic proximity to the delivery driver location.

7. The undeliverable package management system of claim 1, wherein the prioritized list only includes retail store locations with a line haul scheduled at a time such that the undeliverable package, if returned to the store, can be picked up by the line haul on the same day the package was undeliverable.

8. The undeliverable package management system of claim 1, wherein each of the plurality of retail store locations has a storage locker configured to receive the undeliverable package, and the space availability information is based on the amount of space available in the storage locker to receive the undeliverable package.

9. The undeliverable package management system of claim 8, wherein the instructions sent to the delivery driver computing device include an access code to access the storage locker.

10. The undeliverable package management system of claim 9, wherein the instructions, when executed, further cause the system to:
based on receiving a notification that the access code was utilized to return the undeliverable package to the selected return location, automatically update the space availability information.

11. The undeliverable package management system of claim 9, wherein the instructions, when executed, further cause the system to:
based on receiving a notification that the access code was utilized to return the undeliverable package to the selected return location, send a confirmation message to a retailer computing device indicating that the undeliverable package has been returned to the return location and providing instructions to unload the undeliverable package from the storage locker to a line haul.

12. The undeliverable package management system of claim 6, wherein the instructions, when executed, further cause the system to:
based on receiving a notification that the access code was utilized to return the undeliverable package to the selected return location, send a delivery option notification to a customer computing device providing the customer with an option to switch from delivery to a pickup option for the undeliverable package.

13. The undeliverable package management system of claim 9, wherein the access code comprises a scannable access code and the instructions, when executed, further cause the system to, in response to receiving a notification that the access code was scanned to return the undeliverable package, automatically send an update to the user interface of the delivery driver computing device including a selectable option, wherein the selectable option is selectable by the delivery driver to confirm that the undeliverable package was returned to the selected return location.

14. A method for managing an undeliverable package comprising:
receiving a notification from a delivery driver computing device indicating that a package was undeliverable during a delivery route, wherein the notification includes a delivery driver location at an end of the delivery route;
in response to receiving the notification that the package was undeliverable, receiving space availability information indicating an amount of space available at a plurality of candidate return locations, the plurality of candidate return locations including one or more retail locations selected from among a plurality of retail store locations, the plurality of candidate return locations being capable of receiving the undeliverable package and including at least one candidate return location that is different from a pickup location of the undeliverable package;
accessing an external data store storing line haul schedule information indicating times at which a line haul will arrive at each of the plurality of candidate return locations to pick up items for transport to a sortation center;
based on the delivery driver location, the space availability information, and the line haul schedule information, generating a prioritized list from among the plurality of candidate return locations to which the undeliverable item may be returned;
providing, to the delivery driver computing device, the prioritized list for display on a user interface of a mobile application installed thereon;
receiving, from the delivery driver computing device, a selection of a return location from the prioritized list; and
in response to receiving a selection of a return location, automatically generating and sending to the delivery driver computing device instructions for returning the undeliverable package to the selected return location.

15. The method of claim 14, wherein generating the prioritized list comprises:
identifying, as the plurality of candidate return locations, a plurality of retail store locations within a predetermined geographic proximity of the delivery driver's location;
for each of the plurality of candidate return locations, determining whether the candidate return location has space to receive the undeliverable package based on the space availability information;
for each of the candidate return locations with space to receive the undeliverable package that is a retail store location, determining when a line haul is scheduled to pick up items from the retail store location based on the line haul schedule information; and
prioritizing, among the plurality of candidate return locations, any retail store location with a line haul scheduled at a time such that the undeliverable package, if returned to the store, can be picked up by the line haul on the same day as the day the package was undeliverable.

16. The method of claim 15, wherein generating the prioritized list further comprises:
based on determining when a line haul is scheduled to pick up items from the retail store locations, excluding from the prioritized list any retail store locations that do not have a line haul scheduled at a time such that the undeliverable package, if returned to the store, can be picked up by the line haul on the same day as the day the package was undeliverable.

17. The method of claim 14, wherein each of the plurality of retail store locations has a storage locker configured to receive the undeliverable package, and the space availability information is based on the amount of space available in the storage locker to receive the undeliverable package, and wherein the instructions sent to the delivery driver computing device include an access code to access the storage locker.

18. The method of claim 17, further comprising:
based on receiving a notification that the access code was utilized to return the undeliverable package to the selected return location, automatically updating the space availability information.

19. The method of claim 17, further comprising:
based on receiving a notification that the access code was utilized to return the undeliverable package to the selected return location, sending a confirmation message to a retailer computing device indicating that the undeliverable package has been returned to the return location and providing instructions to unload the undeliverable package from the storage locker to a line haul.

20. A system for managing undeliverable packages, the system comprising:
at least one delivery driver computing device including a mobile application installed thereon, the mobile application being configured to generate a user interface presentable to a delivery driver; and
a computing system including a database, a processor, and a memory communicatively coupled to the processor, the memory storing instructions executable by the processor to:
receive a notification from the delivery driver computing device indicating that a package was undeliverable, wherein the notification includes a delivery driver location;
identify a plurality of retail store locations within a predetermined geographic proximity of the delivery driver location;
in response to receiving the notification that the package was undeliverable, receive space availability information indicating an amount of space available at a storage locker at the plurality of retail store locations;
for each of the plurality of retail store locations, determine whether the retail store location has space to receive the undeliverable package at the storage locker based on the space availability information;
access an external data store storing line haul schedule information indicating times at which a line haul will arrive at the plurality of retail store locations to pick up items for transport to a sortation center;
for each of the plurality of retail store locations with space to receive the undeliverable package, determine when a line haul is scheduled to pick up items from the retail store location based on the line haul schedule information;
based on the determination of whether the retail store locations have space to receive the undeliverable package, the determination of when a line haul is scheduled to pick up items from the retail store locations, and the geographic proximity between the delivery driver's location and the retail store locations, generate a prioritized list of retail store locations to which the undeliverable item may be returned;
provide for display on the user interface of the delivery driver computing device, the prioritized list of retail store locations;
receive, from the delivery driver computing device, a selection of a retail store location from the prioritized list of retail store locations;
in response to receiving a selection of a retail store location, provide instructions to the delivery driver computing device for display on the user interface, the instructions being directions to the delivery driver for returning the undeliverable package to the selected retail store location, wherein the instructions include an access code to access the storage locker; and
in response to receiving a notification that the access code was utilized to access the storage locker, automatically updating the space availability information at the selected retail store location.
